(19) United States
(12) Patent Application Publication
(10) Pub. No.: US 2017/0344111 A1
(43) Pub. Date: Nov. 30, 2017

(54) EYE GAZE CALIBRATION METHOD AND ELECTRONIC DEVICE THEREFOR

(71) Applicant: Samsung Electronics Co., Ltd., Suwon-si, Gyeonggi-do (KR)

(72) Inventor: Chang-Han KIM, Suwon-si (KR)

(21) Appl. No.: 15/534,765

(22) PCT Filed: Jan. 12, 2015
(86) PCT No.: PCT/KR2015/000285

§ 371 Date: Jun. 9, 2017

(30) Foreign Application Priority Data
Dec. 11, 2014 (KR) 10-2014-0178479

(51) Int. Cl. G06F 3/01; G06K 9/00; G06F 3/0481

(52) U.S. Cl. CPC G06F 3/013; G06K 9/00617; G06F 3/0481

(57) ABSTRACT

Various embodiments of the present invention may comprise: a camera unit for photographing an image in response to an action for which an event is displayed at a position on a screen of an electronic device; and a control unit for controlling to perform calibration of eye gaze on the basis of information associated with a user's eye gaze determined from the photographed image and information regarding the position on the screen at which the event is displayed. In addition, other embodiments are possible for the various embodiments of the present invention.

### CROSS-REFERENCE TO RELATED APPLICATION(S)

This application is a U.S. National Stage application under 35 U.S.C. §371 of an International application filed on Jan. 12, 2015 and assigned application number PCT/KR2015/000285, which claimed the benefit of a Korean patent application filed on Dec. 11, 2014 in the Korean Intellectual Property Office and assigned Serial number 10-2014-0178479, the entire disclosure of which is hereby incorporated by reference.

### TECHNICAL FIELD

Various embodiments of the present invention relate to a gaze calibration method, and an electronic device thereof.

### BACKGROUND ART

As methods of determining and/or tracking a user gaze by an electronic device, methods of determining and tracking a gaze using information associated with an iris, pupil, or glint of a cornea, or the like have been conducted.

The electronic device may lead a user to gaze at a predetermined location to determine a portion of a display screen that the user gazes at, and may analyze, for example, the user's iris, pupil, glint of a cornea, or the like, thereby modeling a direction of a gaze. To analyze a user gaze, a correction process is required to match a point on a display screen that the user actually gazes at and a point recognized by the electronic device. This process is referred to as gaze calibration.

### DETAILED DESCRIPTION OF THE INVENTION

### Technical Problem

To track a user gaze, calibration needs to be performed by leading a user to gaze at various points of a screen before tracking the gaze, which is burdensome.

Also, although the calibration process is performed at the initial stage, a gaze location or area tracked by an electronic device and a gaze location or area that the user actually gazes at may have a difference due to a change in a state of a display (e.g., a change in a location), a change in a location of the user, a change of an environment, or the like.

Various embodiments of the present invention may provide a gaze calibration method and electronic device thereof, which may process a gaze calibration in parallel with a gaze tracking when a user gazes at a display.

### Technical Solution

According to an embodiment of the present invention, there is provided an electronic device, including: a camera unit that captures an image in response to an operation of displaying an event in a location on a screen of the electronic device; and a controller that performs control to calibrate a gaze based on information associated with a user gaze determined from the captured image, and location information associated with the location on the screen where the event is displayed.

According to an embodiment of the present invention, there is provided an operation method of an electronic device, the method including: when at least one event occurs in the electronic device, determining whether the event is a predetermined event; capturing an image through a camera when the event is the predetermined event; and calibrating a user gaze, which is determined from the captured image, based on location information associated with a location on a screen corresponding to the event.

### Advantageous Effects

A gaze calibration method and an electronic device thereof, according to various embodiments, may manually perform only a minimum calibration process or may perform calibration while a user utilizes the electronic device but does not realize that calibration is performed, without a separate calibration process.

Also, a gaze calibration method and an electronic device thereof, according to various embodiments, may process a calibration in parallel with a gaze tracking while a user uses the electronic device.

### BRIEF DESCRIPTION OF THE DRAWINGS

FIG. 1 illustrates an example of a configuration of an electronic device according to various embodiments of the present invention;

FIG. 2 is a flowchart illustrating a gaze calibration procedure according to various embodiments of the present invention;

FIG. 3 is a flowchart illustrating a gaze calibration procedure according to various embodiments of the present invention;

FIG. 4 is a flowchart illustrating a gaze calibration procedure according to various embodiments of the present invention;

FIG. 5 is a flowchart illustrating a calibration error determining procedure according to various embodiments of the present invention;

FIG. 6 is a flowchart illustrating a calibration information updating procedure according to various embodiments of the present invention;

FIG. 7 illustrates an example of occurrence of an event according to various embodiments of the present invention;

FIG. 8 illustrates an example of occurrence of an event according to various embodiments of the present invention;

FIG. 9 illustrates an example of occurrence of an event according to various embodiments of the present invention;

FIG. 10 illustrates a user gaze according to various embodiments of the present invention;

FIG. 11 illustrates a gaze calibration screen according to various embodiments of the present invention;

FIG. 12 illustrates modeling of gaze tracking according to various embodiments of the present invention;

FIG. 13 illustrates an example of a gaze predicting method according to various embodiments of the present invention;

FIG. 14 illustrates changing of an event occurrence location according to various embodiments of the present invention;

FIG. 15 is a block diagram illustrating a detailed structure of an electronic device according to an embodiment of the present invention; and

FIG. 16 is a block diagram of a program module according to various embodiments of the present invention.

### MODE FOR CARRYING OUT THE INVENTION

Hereinafter, various embodiments of the present invention will be described with reference to the accompanying drawings. However, it should be understood that there is no intent to limit the present invention to particular forms, and the present invention should be construed to cover all modifications, equivalents, and/or alternatives falling within the spirit and scope of the embodiments of the present invention. In the description of the drawings, similar reference numerals may be used to designate similar elements.

As used herein, the expression “have”, “may have”, “include”, or “may include” refers to the existence of a corresponding feature (e.g., numeral, function, operation, or constituent element such as component), and does not exclude one or more additional features.

In the present invention, the expression “A or B”, “at least one of A or/and B”, or “one or more of A or/and B” may include all possible combinations of the items listed. For example, the expression “A or B”, “at least one of A and B”, or “at least one of A or B” may include (1) at least one A, (2) at least one B, or (3) both at least one A and at least one B.

The expression “a first”, “a second”, “the first”, or “the second” used in various embodiments of the present invention may modify various components regardless of the order and/or the importance but does not limit the corresponding components. The above-described expressions may be used to distinguish an element from another element. For example, a first user device and a second user device indicate different user devices although both of them are user devices. For example, a first element may be termed a second element, and similarly, a second element may be termed a first element without departing from the scope of the present invention.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

As used herein, the expression “configured to” may be interchangeably used with the expression “suitable for”, “having the capability to”, “designed to”, “adapted to”, “made to”, or “capable of”. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

The terms used in the present invention are only used to describe specific embodiments, and are not intended to limit the present invention. A singular expression may include a plural expression unless they are definitely different in a context. Unless defined otherwise, all terms used herein, including technical terms and scientific terms, may have the same meaning as commonly understood by a person of ordinary skill in the art to which the present invention pertains. Terms, such as those defined in commonly used dictionaries, should be interpreted as having a meaning that is the same or similar to their meaning in the context of the relevant art and will not be interpreted in an idealized or overly formal sense unless expressly so defined herein. In some cases, even the term defined in the present invention should not be interpreted to exclude embodiments of the present invention.

For example, the electronic device may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g., a head-mounted-device (HIVID) such as electronic glasses, electronic clothes, an electronic bracelet, an electronic necklace, an electronic appcessory, electronic tattoos, or a smart watch).

According to some embodiments, the electronic device may be a smart home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR) , a Flight Data Recorder (FDR) , a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present invention may be a combination of one or more of the aforementioned various devices. The electronic device according to some embodiments of the present invention may be a flexible device. Further, the electronic device according to an embodiment of the present invention is not limited to the aforementioned devices, and may include a new electronic device according to the development of technology.

The term used in the following descriptions, ‘gaze calibration’, may indicate correction for matching a location on a display screen that a user actually gazes at and a location on the screen that an electronic device recognizes, to analyze a user gaze.

Hereinafter, an electronic device according to various embodiments will be described with reference to the accompanying drawings. In the present invention, the term “user” may indicate a person using an electronic device or a device (e.g., an artificial intelligence electronic device) using an electronic device.

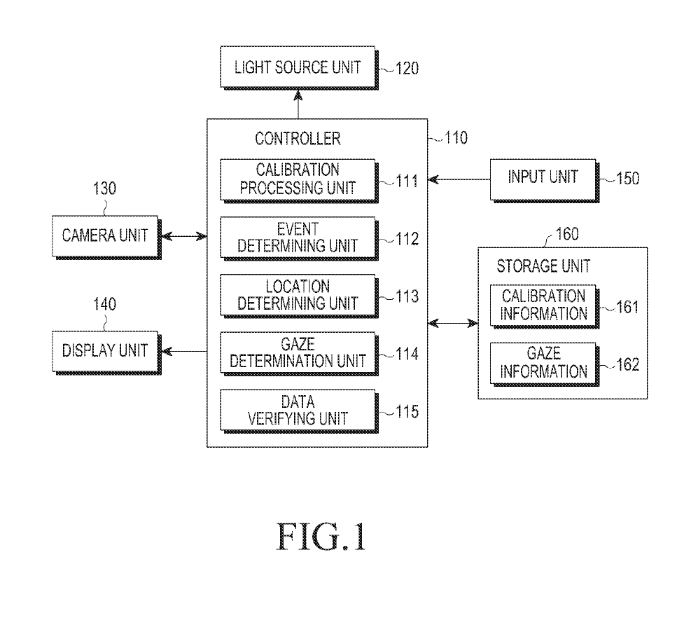

FIG. 1 illustrates an example of a configuration of an electronic device according to various embodiments of the present invention. Referring to FIG. 1, an electronic device according to various embodiments may include at least one of a controller 110, a light source unit 120, a camera unit 130, a display unit 140, an input unit 150, and a storage unit 160. Also, the controller 110 may include at least one of a calibration processing unit 111, an event determining unit 112, a location determining unit 113, a gaze determination unit 114, and a data verifying unit 115.

The calibration processing unit 111 may perform a function of processing calibration with respect to a user gaze. Various methods may be applied as a method of processing calibration with respect to the user gaze, and detailed embodiments will be described.

The calibration may include correction for matching a location on a display screen that the user actually gazes at and a location on the screen recognized by the electronic device, to analyze a user gaze.

The event determining unit 112 may determine occurrence of an event in association with various events that are feasible in the electronic device, and may determine at least one piece of event related information which is related to the event that has occurred (e.g., a type of event, an occurrence time of an event, property information of an event, or the like).

According to various embodiments of the present invention, an event type of the event may be an input event in which a user provides an input through the input unit 150. For example, the event may be a click event made by a mouse, or may be a touch event in which a user touches a predetermined location on a touch screen. Also, the event may be various gesture events in which a user may select a predetermined location on a screen.

The term, “gesture,” used in various embodiments of the present invention may indicate a movement that a user makes using a body part or a part of an object associated with the user, but may not be limited to a movement of a predetermined body part such as a finger, a hand, or the like. For example, the gesture may be construed as a meaning including various motions such as folding of an arm, a movement of a head, a movement using a pen, and the like.

For example, the gesture may include motions, such as a touch, a release of a touch, a rotation, a pinch, a spread, a touch drag, a flick, a swipe, a touch and hold, a tap, a double-tap, a drag, a drag and drop, multi-swipe, a shake, a rotation, and the like. Further, a touch state may include a contact of a finger to a touch screen or a very close access of the finger to the touch screen without actual contact.

Also, according to various embodiments of the present invention, the type of event may be an output event that is displayed through the display unit 140. For example, the event may be a pop-up window generation event that generates a pop-up window in a predetermined location on a screen.

The location determining unit 113 may determine a location on a screen corresponding to an event determined through the event determining unit 112. For example, when the generated event is a touch event whereby a a predetermined location on a screen is touched, the location determining unit 113 may determine a location on the screen where the touch event occurs. Also, for example, when the event that has occurred is a mouse click event, the location determining unit 113 may determine a location (e.g., the location of a cursor) on the screen, which is selected by a mouse click. Also, for example, when the event that has occurred is an event that generates and displays a pop-up window on a screen, the location determining unit 113 may determine a location on the screen where the pop-up window is displayed.

According to various embodiments of the present invention, the location information determined by the location determining unit 113 may be coordinate information (e.g., the coordinate of a pixel) indicating a predetermined point on a display screen, or may be location information associated with an area including at least one coordinate.

The gaze determination unit 114 may perform a function of determining a user gaze. Also, the gaze determination unit 114 may determine a user gaze, and may further perform a function of tracking the user gaze.

A gaze determining method of the gaze determination unit 114 may be implemented by various gaze determination algorithms, and various embodiments of the present invention may not be limited to a predetermined algorithm. For example, according to various embodiments of the present invention, the gaze determination unit 114 may perform modeling of the shape of an eyeball using information associated with an iris of a user, pupil, glint of a cornea, or the like, and may determine or track a user gaze through the same.

Also, according to various embodiments of the present invention, the gaze determination unit 114 may determine a user gaze (or a direction of a gaze) by interoperating with the camera unit 130 or the light source unit 120. For example, after capturing the face or an eyeball of a user through the camera unit 130, the gaze determining unit 114 may analyze the captured image and determine a user gaze.

Also, according to various embodiments of the present invention, at least one light source may be emitted through the light source unit 120 under the control of the controller 110. When a light source is emitted through the light source unit 120, the gaze determination unit 114 may capture an image of the face or eyeball of a user through the camera unit 130, and determine a user gaze through the location of a light source that is focused on the eyeball in the captured image.

Calibration information 161 processed through the calibration processing unit 111 and/or gaze information 162 determined through the gaze determination unit 114 may be stored in the storage unit 160. Also, according to various embodiments of the present invention, the calibration information 161 and/or the gaze information 162 may be stored to correspond to each piece of user information.

According to various embodiments of the present invention, the calibration processing unit 111 may be embodied to perform calibration through a separate calibration setting menu. For example, when a user executes a calibration function, a mark is displayed in at least one set location on a screen through the display unit 140, and when the user gazes at the mark displayed on the screen, the user gaze may be calibrated in association with a location on the screen that the user gazes at. For example, as a function of the calibration, correction may be performed for matching a location on a display screen that the user gazes at and a location on the screen recognized by the electronic device.

Also, according to various embodiments of the present invention, when it is determined that a predetermined event (e.g., an event of which location information associated with a location on a screen corresponding to the event is identifiable) has occurred through the event determining unit 112, the calibration processing unit 111 may perform a calibration procedure without conversion to a separate calibration setting menu. When calibration is performed when the predetermined event has occurred without the conversion to the separate calibration setting menu, a user may not recognize that the electronic device performs calibration. The execution of calibration according to the embodiment may not affect when a user utilizes an electronic device (e.g., execution of various applications, web browsing, and the like) thereby enabling the user to conveniently utilize the electronic device.

According to various embodiments of the present invention, calibration through the separate calibration setting menu and calibration performed without conversion to a calibration setting menu when the event has occurred, may be provided in parallel. Alternatively, calibration may be implemented to perform calibration only when an event occurs, without setting a separate calibration.

Also, according to various embodiments of the present invention, calibration may be implemented to perform rough calibration through a separate calibration setting menu at the initial stage, and to perform accurate calibration when a predetermined event occurs.

The data verifying unit 115 may verify calibration set in advance according to various embodiments of the present invention. For example, when an event of which a location on a screen is determined according to various embodiments of the present invention has occurred in the state in which the calibration information 161 is stored in the storage unit 160, the data verifying unit 115 may generate calibration information using location information associated with a location on a screen where the event has occurred, and may verify or update calibration data by comparing the generated calibration information with calibration information 161 stored in advance.

When a predetermined event occurs, the controller 110 may determine and/or track a gaze through the gaze determination unit 114, and at the same time, may perform calibration through the calibration processing unit 111 according to various embodiments of the present invention.

The controller 110 may be referred to as a processor, and the controller 110 may include one or more of a central processing unit (CPU), an application processor (AP), and a communication processor (CP). For example, the controller 110 may carry out operations or data processing related to control and/or communication of at least one other element of the electronic device.

The storage unit 160 may include a volatile memory and/or a non-volatile memory. The storage unit 160 may store, for example, instructions or data related to at least one other element of the electronic device 101. According to an embodiment of the present invention, the storage unit 160 may store software and/or a program. The program may include, for example, a kernel, middleware, an application programming interface (API), and/or an application program (or “application”). At least some of the kernel, the middleware, and the API may be referred to as an operating system (OS).

The kernel may control or manage system resources (e.g., the bus, the processor, the storage unit 160, or the like) used for performing operations or functions implemented by the other programs (e.g., the middleware, the API, or the application programs). Also, the kernel may provide an interface through which the middleware, the API, or the application programs may access the individual elements of the electronic device to control or manage the system resources.

The middleware may serve as an intermediary so that, for example, the API or the application program communicates with the kernel, and exchanges data. Furthermore, in regard to task requests received from the applications, the middleware may perform control (e.g., scheduling or load balancing) for the task requests, using a method such as allocating at least one of the applications priority to use the system resources (e.g., a bus, a processor, a memory or the like) of the electronic device.

The API is an interface through which the application, for example, controls functions provided by the kernel or the middleware, and may include, for example, at least one interface or function (e.g., an instruction) for file control, window control, image processing, text control, or the like.

The display 140 may include, for example, a liquid crystal display (LCD), a light emitting diode (LED) display, an organic light emitting diode (OLED) display, a micro electro mechanical system (MEMS) display, or an electronic paper display. The display 140 may display various types of contents (e.g., text, images, videos, icons, or symbols) for users. The display 140 may include a touch screen and may receive, for example, a touch, gesture, proximity, or hovering input using an electronic pen or the user's body part.

Although FIG. 1 illustrates that functions associated with various embodiments of the present invention operate independently in the electronic device, the electronic device may be embodied to include a separate communication interface (not illustrated) so as to communicate with an external electronic device, a server, or the like through a network, and perform some functions according to various embodiments of the present invention.

For example, according to various embodiments of the present invention, the server may support driving of the electronic device by performing at least one operation (or function) implemented in the electronic device. For example, the server may include at least some elements of the controller 110 implemented in the electronic device, and may perform at least one operation from among operations (or functions) executed by the controller 110 (or may cover for the controller 110).

Each functional unit and module in various embodiments of the present invention may indicate a functional or structural coupling of hardware for executing a technical idea of various embodiments of the present invention and software for operating the hardware. For example, the each functional unit or module may indicate a predetermined code and a unit of logic of a hardware resource for performing the predetermined code. However, it will be understood by a person skilled in the technical field of the present invention that the each functional unit does not mean physically connected codes, or a kind of hardware.

An electronic device according to any one of the various embodiments of the present invention may include: a camera unit that captures an image in response to an operation of displaying an event in a location on a screen of the electronic device; and a controller that performs control to calibrate a gaze based on information associated with a user gaze determined from the captured image, and location information associated with the location on the screen where the event is displayed.

According to various embodiments of the present invention, the event may be a predetermined event and of which location information associated with the location where the event is displayed on the screen is identifiable.

According to various embodiments of the present invention, the event may be an input event associated with selecting at least one location on the screen.

According to various embodiments of the present invention, the input event may be a selection event by an input unit to select a location of a cursor displayed on the screen, a touch event on a touch screen, or a user gesture event.

According to various embodiments of the present invention, the event may be an output event associated with an object generated on at least one location on the screen.

According to various embodiments of the present invention, the output event may be a pop-up window generation event that generates a pop-up window on at least one location on the screen.

According to various embodiments of the present invention, the pop-up window may be generated in a location that is different from a previous generation location according to settings.

According to various embodiments of the present invention, the location information associated with a location on the screen may be coordinate information indicating at least one point on a display screen or information associated with an area including the at least one coordinate.

According to various embodiments of the present invention, when a result obtained by comparing predetermined calibration information and calibration information determined when the event occurs exceeds a predetermined error range, the controller may update calibration information with the calibration information determined when the event occurs.

According to various embodiments of the present invention, the controller may perform control to identify a user from the captured image, and to store calibration information generated from the captured image to correspond to user information of the user.

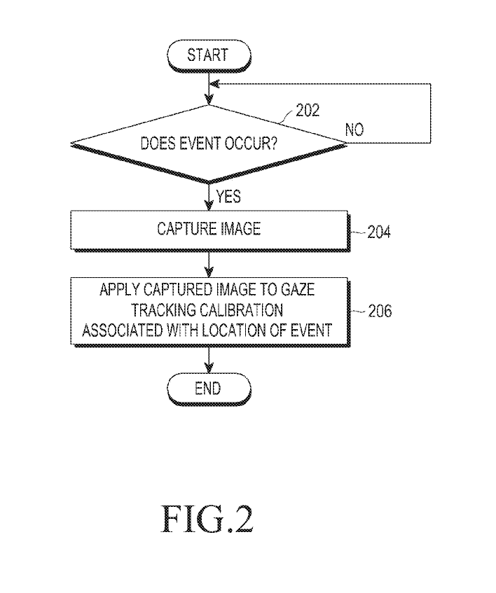

Hereinafter, various embodiments of a gaze calibration method of an electronic device will be described in detail with reference to FIGS. 2 to 6.

FIG. 2 is a flowchart illustrating a gaze calibration procedure according to various embodiments of the present invention. Referring to FIG. 2, according to various embodiments of the present invention, when a predetermined event occurs in operation 202, an image may be captured by operating a camera unit in operation 204. The predetermined event may be, for example, an event of which location information corresponding to the event is identifiable. When it is determined that the predetermined event has occurred, an image of a face or an eyeball is captured through the camera unit, and a calibration procedure may be performed without conversion to a separate calibration setting menu. For example, when calibration is performed when the predetermined event has occurred, without the conversion to the separate calibration setting menu, a user may not recognize that the calibration is performed.

In operation 206, calibration of a location corresponding to the event that has occurred is performed based on the captured image. For example, based on the location information associated with the location on the screen corresponding to the event that has occurred, a user gaze determined from the captured image may be calibrated.

For example, while the user reads a webpage or executes a predetermined application according to various embodiments of the present invention, when the user selects a predetermined location on a screen by clicking a mouse or inputting a touch, it is determined that an event occurring by the selection is a predetermined event, and a calibration procedure may be performed without conversion to a separate calibration setting menu.

Procedures associated with the selection made in a webpage or the execution of an application may be performed continuously, and the calibration may be executed in a background separately from the webpage or application operation. Accordingly, the user may not recognize the calibration operation and the calibration operation not affect the webpage or application operation that is currently executed. Also, when the user executes various tasks through the electronic device, calibration may be performed in parallel with the tasks although the user does not perform calibration in a separate calibration setting menu.

Also, a user gaze may be determined and/or tracked when the user executes a task through the electronic device, and the calibration may be performed in parallel with the gaze determination and/or gaze tracking according to various embodiments of the present invention.

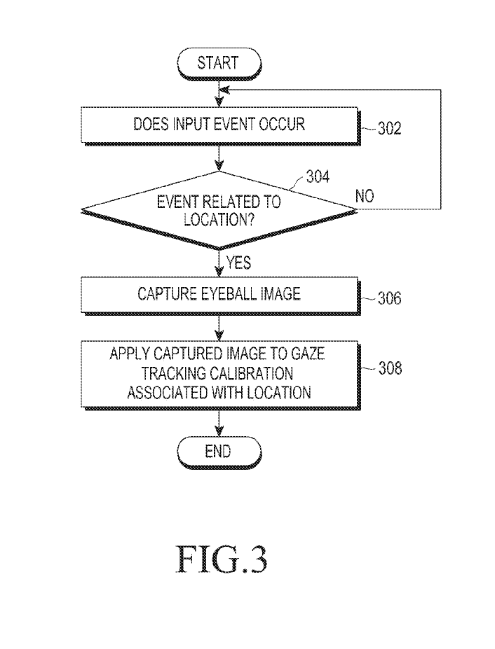

FIG. 3 is a flowchart illustrating a gaze calibration procedure according to various embodiments of the present invention. Referring to FIG. 3, according to various embodiments of the present invention, when an input event occurs in operation 302, it is determined that the input event that has occurred is an event related to a location in operation 304. For example, when the input event that has occurred is an event for selecting a predetermined location on a screen (e.g., an event for selecting a predetermined location on a screen by a mouse, a touch-event for touching a predetermined location on a touch screen by a user, or the like), it is determined that the input event is an event related to a location.

When the determination shows that the event is an event related to a location, an image is captured by operating a camera unit in operation 306. For example, an image of a face or an eyeball is captured through the camera unit, and a calibration procedure may be performed without conversion to a separate calibration setting menu.

In operation 308, calibration of a location corresponding to the event that has occurred is performed based on the captured image. For example, based on the location information associated with the location on a screen corresponding to the event that has occurred, a user gaze determined from the captured image may be calibrated.

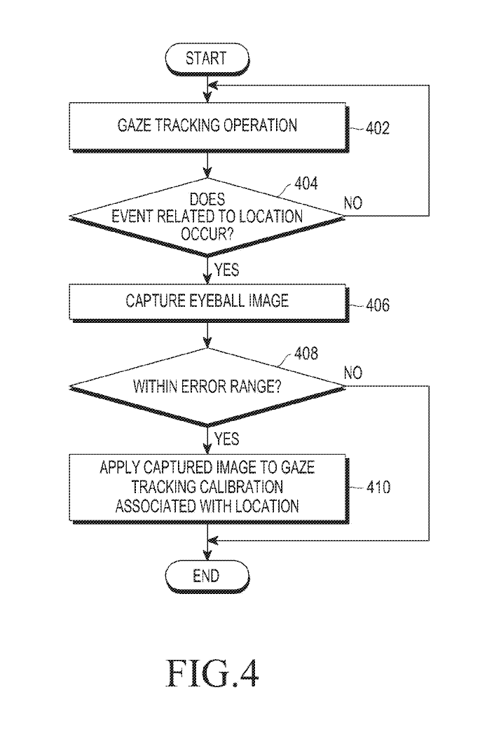

FIG. 4 is a flowchart illustrating a gaze calibration procedure according to various embodiments of the present invention. Referring to FIG. 4, according to various embodiments of the present invention, as various applications are executed, an electronic device tracks a user gaze in operation 402. Gaze tracking information of the user may be applied to execution of the application. For example, by tracking a user gaze, a screen may be scrolled, a predetermined location where the user gazes at may be selected, or screen zooming may be performed based on a location which the user gazes at.

When the input event occurs, it is determined whether the input event that has occurred is an event related to a location in operation 404. For example, when the input event that has occurred is an event for selecting a predetermined location on a screen (e.g., an event for selecting a predetermined location on a screen by a mouse, a touch-event for touching a predetermined location on a touch screen by a user, or the like), it is determined that the input event is an event related to a location.

When the determination shows that the event is an event related to a location, an image is captured by operating a camera unit in operation 406. For example, an image of a face or an eyeball is captured through the camera unit, and a calibration procedure may be performed without conversion to a separate calibration setting menu. For example, according to various embodiments of the present invention, a gaze calibration operation may be performed in parallel with the gaze tracking operation.

For example, calibration of a location corresponding to the event that has occurred may be performed based on the captured image. Also, based on the location information associated with the location on a screen corresponding to the event that has occurred, a user gaze determined from the captured image may be calibrated.

When a result obtained by comparing the calibration information and calibration information set in advance is within a predetermined error range in operation 408, the calibration information set in advance may be corrected to more accurate information by applying the calibration information obtained by performing calibration as the event occurs in operation 410.

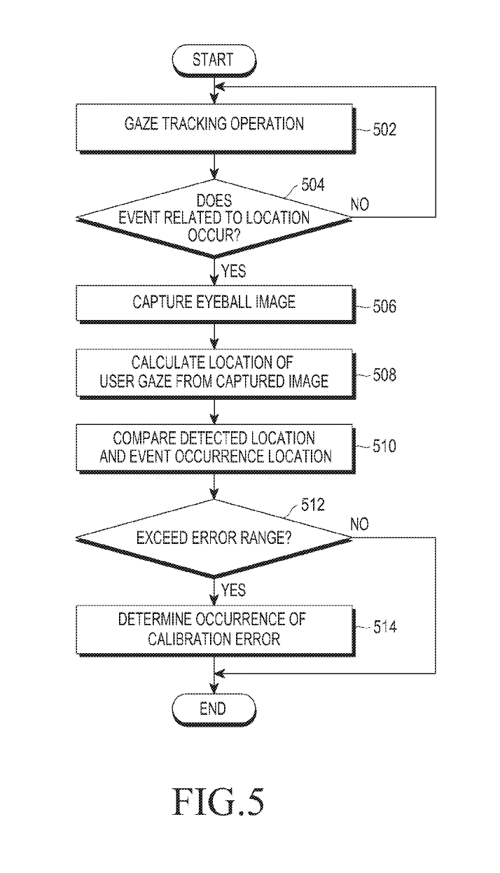

FIG. 5 is a flowchart illustrating a calibration error determining procedure according to various embodiments of the present invention. Referring to FIG. 5, according to various embodiments of the present invention, as various applications are executed, an electronic device tracks a user gaze in operation 502. Gaze tracking information of the user may be applied to execution of the application. For example, by tracking a user gaze, a screen may be scrolled, a predetermined location where the user gazes at may be selected, or screen zooming may be performed based on a location which the user gazes at.

When the input event occurs, it is determined whether the input event that has occurred is an event related to a location in operation 504. For example, when the input event that has occurred is an event for selecting a predetermined location on a screen (e.g., an event for selecting a predetermined location on a screen by a mouse, a touch-event for touching a predetermined location on a touch screen by a user, or the like), it is determined that the input event is an event related to a location.

When the determination shows that the event is an event related to a location, an image is captured by operating a camera unit in operation 506. For example, the location on the screen corresponding to the user gaze may be calculated by capturing an image of a face or an eyeball through the camera unit and using calibration information obtained from the captured image and stored in advance in operation 508.

In operation 510, the location on the screen determined through the gaze determination and the location where the event has occurred may be compared. When the comparison shows that a difference exceeds the error range in operation 512, it is determined that an error occurs in the calibration information stored in advance in operation 514.

When it is determined that an error occurs in the calibration information stored in advance in operation 514, an operation corresponding to the occurrence of an error may be performed according to various embodiments of the present invention.

For example, according to various embodiments of the present invention, whether the error occurs may be displayed on a screen, and a calibration procedure may be induced to be performed through conversion to a separate calibration setting menu. Also, according to various embodiments of the present invention, a calibration operation may be performed using location information corresponding to the event that has occurred and an image captured when the event has occurred, and the calibration information set in advance may be updated with the calibration information that has changed through the executed calibration.

Also, when it is determined that an error occurs in the calibration stored in advance according to various embodiments of the present invention, the number of errors that occur may be counted and when the number of errors that occur exceeds a predetermined number, set calibration information may be updated.

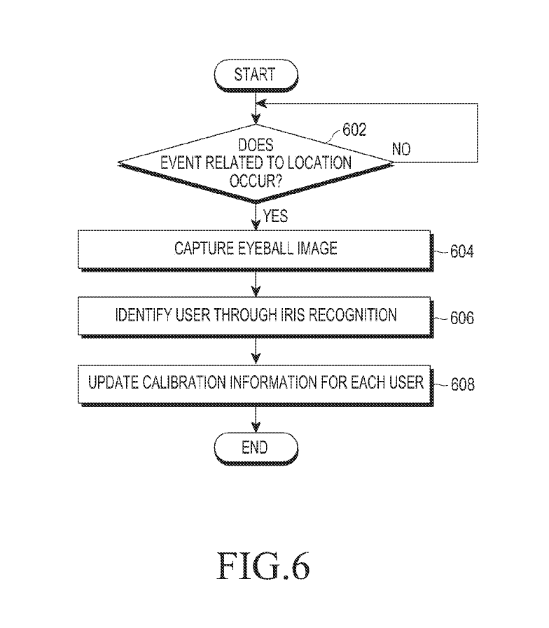

FIG. 6 is a flowchart illustrating a calibration information updating procedure according to various embodiments of the present invention. Referring to FIG. 6, according to various embodiments of the present invention, when a predetermined event occurs in operation 602, an image may be captured by operating a camera unit in operation 604. The predetermined event may be, for example, an event of which location information corresponding to the event is identifiable. When it is determined that the predetermined event has occurred, an image of a face or an eyeball is captured through the camera unit, and a calibration procedure may be performed without conversion to a separate calibration setting menu. For example, when calibration is performed when the predetermined event has occurred, without the conversion to the separate calibration setting menu, a user may not recognize that the calibration is performed.

According to various embodiments of the present invention, an iris is recognized from the captured image and thus, the user may be identified in operation 606. For example, the calibration information generated from the captured image may correspond to the user identified from the captured image.

In operation 608, calibration information may be stored or updated for each identified user.

Also, according to various embodiments of the present invention, a user who performs calibration may be recognized. Further, information associated with each situation when a user performs calibration may be collected, and situation information of each user and calibration information may be stored to correspond to each other. Accordingly, when the electronic device determines and/or tracks a gaze, the electronic device may determine current situation information of a user, and apply calibration information corresponding to the current situation, thereby accurately determining and/or tracking a gaze.

At least one of the operations illustrated in FIGS. 2 to 6 may be omitted, or at least one other operation may be added between the operations. In addition, the operations of FIG. 2 or 6 may be performed in the shown sequence. Alternatively, an execution sequence of at least one operation may be exchanged with an execution sequence of another operation.

An operation method of an electronic device according to any one of the various embodiments of the present invention may include: when at least one event occurs in the electronic device, determining whether the event is a predetermined event; capturing an image through a camera when the event is the predetermined event; and calibrating a user gaze, which is determined from the captured image, based on location information associated with a location on a screen corresponding to the event.

According to various embodiments of the present invention, the event may be a predetermined event and of which location information associated with a location on the screen corresponding to the event is identifiable.

According to various embodiments of the present invention, the event may be an input event associated with selecting at least one location.

According to various embodiments of the present invention, the input event may be a selection event by an input unit to select a location of a cursor displayed on a screen, a touch event on a touch screen, or a user gesture event.

According to various embodiments of the present invention, the event may be an output event associated with an object that is generated on at least one location on the screen.

According to various embodiments of the present invention, the output event may be a pop-up window generation event that generates a pop-up window on at least one location on the screen.

According to various embodiments of the present invention, the pop-up window may be generated in a location that is different from a previous generation location according to settings.

According to various embodiments of the present invention, the location information associated with a location on the screen may be coordinate information indicating at least one point on a display screen or information associated with an area including the at least one coordinate.

According to various embodiments of the present invention, the operation method may further include: comparing predetermined calibration information and calibration information determined when the event occurs; and updating calibration information with the calibration information determined when the event occurs when a comparison result exceeds a predetermined error range.

According to various embodiments of the present invention, the operation method may further include: identifying a user from the captured image; and storing calibration information generated from the captured image to correspond to user information.

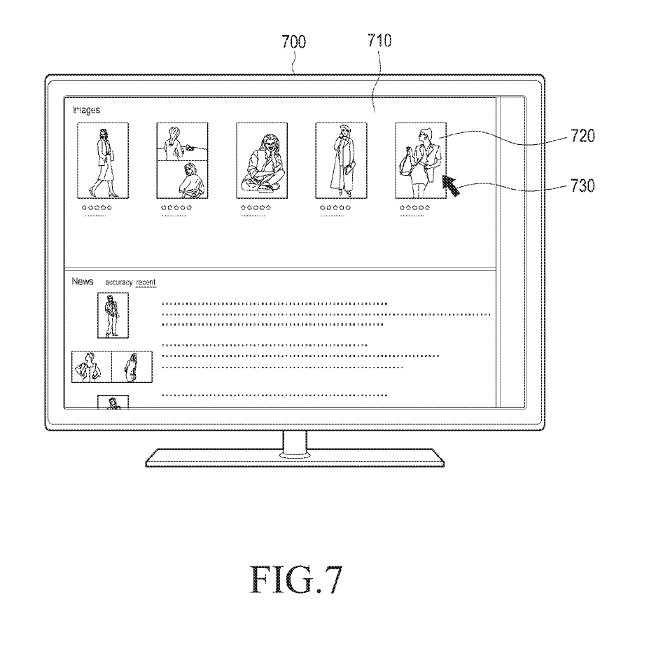

FIG. 7 illustrates an example of occurrence of an event according to various embodiments of the present invention. Referring to FIG. 7, a webpage may be displayed on a screen 710 of an electronic device 700 (e.g., a TV or monitor), and a cursor 730 may be displayed to enable a user to select a predetermined location.

According to various embodiments of the present invention, it is determined that the user gazes at a location of the cursor 730 on the screen. Also, when the user selects a location on the screen 710 where the cursor 730 is displayed, with various selecting means (e.g., a finger, a keyboard, a mouse, and the like) according to various embodiments of the present invention, the electronic device 700 may determine that the user gazes at a location 720 on the screen where the cursor 730 is displayed.

When the location on the screen where the cursor 730 is displayed is selected, an input event related to selection may occur. According to various embodiments of the present invention as described above, a calibration operation may be performed in association with the occurrence of the input event related to selection. For example, when the input event occurs, the image of the face or an eyeball of the user may be captured through a camera and calibration may be performed using the captured image and location information associated with the location where the selection event occurs (e.g., information associated with the location 730 on the screen where the cursor 730 is displayed).

According to various embodiments of the present invention, a process of performing calibration may not be displayed on a screen, and may be an operation that the user may not recognize. Also, the process of performing calibration may be executed in a background without the execution of a separate calibration execution menu.

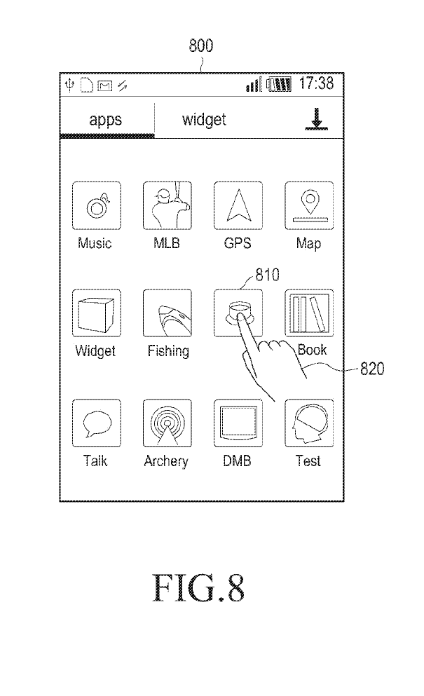

FIG. 8 illustrates an example of occurrence of an event according to various embodiments of the present invention. Referring to FIG. 8, various application icons may be displayed on an application menu screen of an electronic device 800 (e.g., a smart phone).

According to various embodiments of the present invention, when a user selects a predetermined application icon 810 on a touch screen using a finger 820 or an electronic pen, it is determined that the user gazes at a location of the selected application 810.

When the predetermined application icon 810 is selected, an input event related to selection may occur. According to various embodiments of the present invention as described above, a calibration operation may be performed in association with the occurrence of the input event related to selection. For example, when the input event occurs, the image of the face or an eyeball of the user may be captured through a camera and calibration may be performed using the captured image and location information associated with the location where the selection event occurs (e.g., location information associated with the location on the screen where the application icon 810 is displayed).

According to various embodiments of the present invention, a process of performing calibration may not be displayed on the screen, and may be an operation that the user may not recognize. Also, the process of performing calibration may be executed in a background without the execution of a separate calibration execution menu.

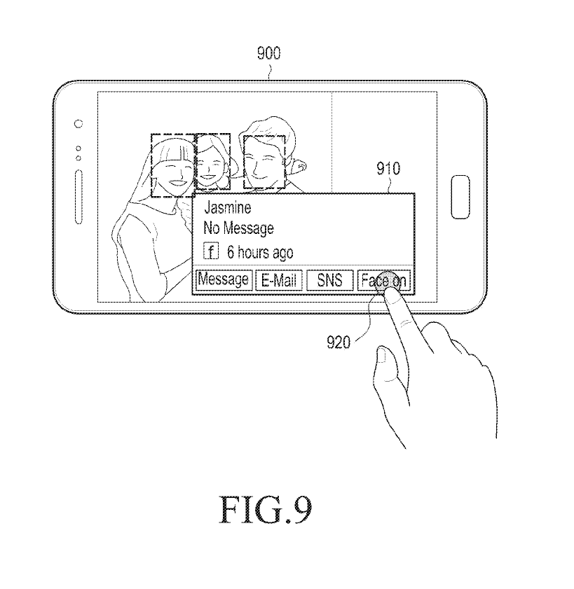

FIG. 9 illustrates an example of occurrence of an event according to various embodiments of the present invention. Referring to FIG. 9, a pop-up window 910 for performing a function may be displayed on a picture view application execution screen (e.g., gallery) of an electronic device 900 (e.g., a smart phone).

According to various embodiments of the present invention, when a user selects a predetermined selection button 920 (or selection box) of the pop-up window on a touch screen using a finger or an electronic pen, it is determined that the user gazes at a location on the screen where the selected selection button 920 is displayed.

When the predetermined selection button is selected in the pop-up window, an input event related to selection may occur. According to various embodiments of the present invention as described above, a calibration operation may be performed in association with the occurrence of the input event related to selection. For example, when the input event occurs, the image of the face or an eyeball of the user may be captured through a camera and calibration may be performed using the captured image and location information associated with the location where the selection event occurs (e.g., location information associated with the location of the selection box 920 of the pop-up window).

According to various embodiments of the present invention, a process of performing calibration may not be displayed on a screen, and may be an operation that the user may not recognize. Also, the process of performing calibration may be executed in a background without the execution of a separate calibration execution menu.

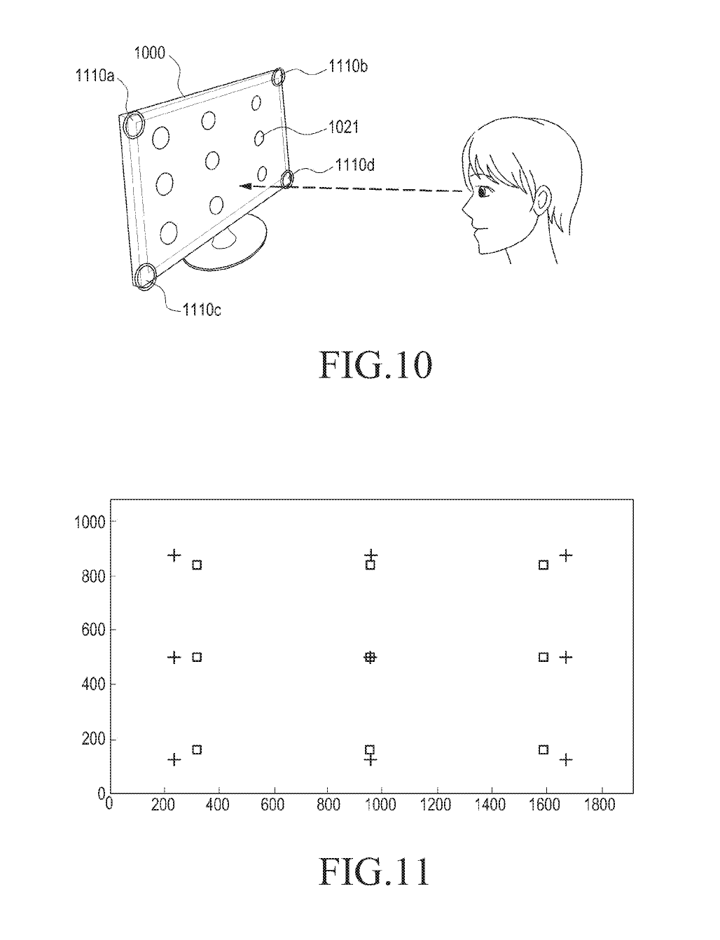

FIG. 10 illustrates a user gaze according to various embodiments of the present invention. Referring to FIG. 10, when a calibration setting menu is executed, a plurality of marks 1021 for calibration may be displayed on a screen of a monitor 1000.

Also, at least one light source 1110a, 1110b, 1110c, and 1110d may be installed to at least a corner of the monitor. For example, when a calibration setting function is executed, the at least one light source 1110a, 1110b, 1110c, and 1110d may be emitted, and the emitted light source may be focused on an eyeball of the user.

The image of the face or an eyeball of the user may be captured through a camera included in the monitor. When the image of the face or eyeball of the user is captured in the state in which the user gazes at a predetermined mark 1021 displayed on the screen of the monitor 1000, the user may calibrate user gaze through at least one light source focused on the captured image.

FIG. 11 illustrates a gaze calibration screen according to various embodiments of the present invention. Referring to FIG. 11, when a user gazes at a location displayed in a monitor, a corresponding location on a screen determined based on calibration information stored in advance, may be different from the location of a mark actually displayed on the screen. When the difference of the locations exceeds an error range, calibration information may be updated through performing calibration according to various embodiments of the present invention.

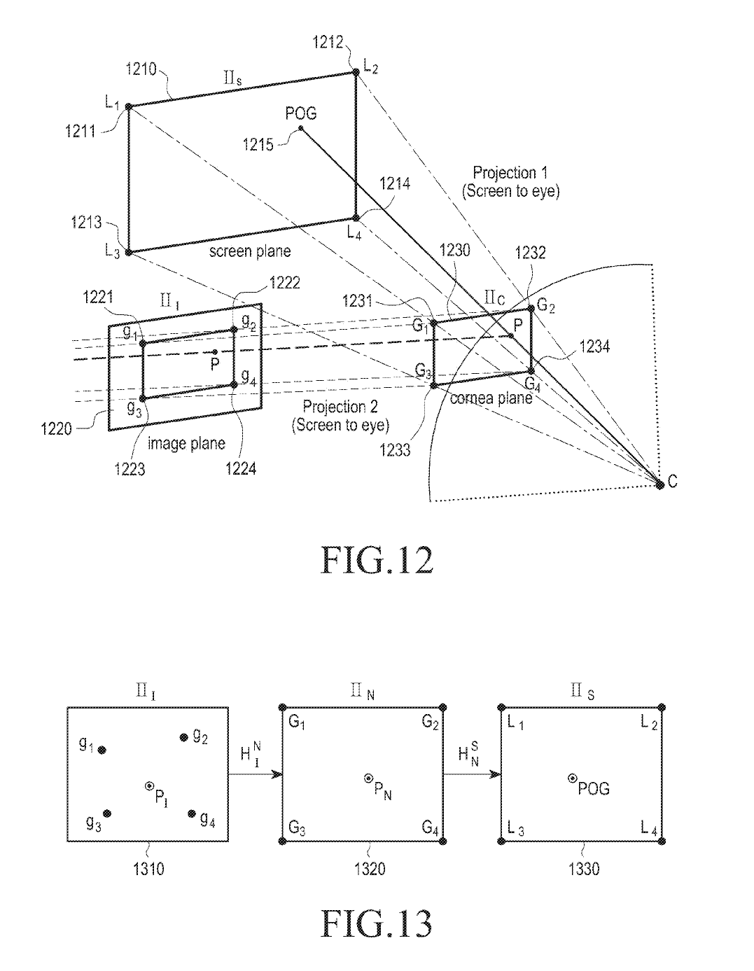

FIG. 12 illustrates modeling of gaze tracking according to various embodiments of the present invention. Referring to FIG. 12, a gaze tracking may be modeled in various methods.

According to various embodiments of the present invention, a technology that predicts and tracks a point of gaze (POG) at which a user gaze is focused on a screen may be applied to various embodiments of the present invention.

For example, for accurate gaze tracking, an infrared (IR) camera, an infrared LED illumination device, and the like may be used, in addition to a visible camera. The above mentioned scheme may use a pupil center (PC) coordinate and a corneal reflection (CR) coordinate at which an IR illumination is reflected from an eyeball. This is referred to as a pupil center corneal reflection (PCCR) scheme, and various gaze tracking methods may exist according to the number of CRs.

FIG. 12 illustrates a geometrical model that a homography normalization (HN) scheme employs. The HN model includes three planes. Included are a monitor screen plane Π_{S} 1210 including IR light sources L₁ to L₄ 1211, 1212, 1213, and 1214 that are attached to the four corners of a screen, a corneal plane Π_{C} 1230 formed of four CRs G₁ to G₄ 1231, 1232, 1233, and 1234, and a camera image plane Π_{I} 1220.

According to a process of obtaining an input eyeball image, four IR light sources L₁ to L₄ 1211, 1212, 1213, and 1214 are focused on a cornea (G₁ to G₄ 1231, 1232, 1233, and 1234), and subsequently, G₁ to G₄ 1231, 1232, 1233, and 1234 and a point, PC (P), on the plane Π_{C} 1230 may be focused on the image plane Π_{I} 1220 through a camera. Therefore, PC (p) and four CRs g₁ to g₄ 1221, 1222, 1223, and 1224 of the eyeball image may be generated.

FIG. 13 illustrates a PCCR scheme-based geometrical model that may be applied to various embodiments of the present invention. HN scheme-based POG prediction may include two mapping functions (MF) as illustrated in FIG. 13. Mapping of Π_{I} 1310 to Π_{N} 1320 and mapping of Π_{N} 1320 to Π_{S} 1330 may be included. Here, Π_{N} 1320 may indicate a normalized plane having a size of a unit square.

p_{I}, which is a PC detected from an eyeball image, may be mapped to the Π_{N} plane 1320 through a homography function H^{N}_{I}. This may be performed using four CRs g₁-g₄ on the plane Π_{I} 1310 and four corner points G₁-G₄ on the plane Π_{N} 1320.

A final POG may be obtained by mapping p_{N}, which is a PC on the plane Π_{N} 1320, to a point on the plane Π_{S} 1330 using a function H^{S}_{N}. H^{S}_{N} may be obtained through a calibration process.

According to various embodiments, an entire mapping function may be expressed as H^{S}_{I}, and mapping from the plane Π_{I} 1310 to the plane Π_{S} 1330 may be performed through the function.

For calibration, a user is led to sequentially gaze at four or nine (or more) points on a screen. PC coordinates (P_{N}) on the plane Π_{N} 1320 at each point may be stored and homography function H^{S}_{N} associated with corresponding coordinates on the corresponding screen may be calculated. In the stage, “ransac” or a least square algorithm may be used as a method of minimizing an error.

The calibration method is an embodiment that may be applied to at least one out of various embodiments of the present invention. Various calibration methods, in addition to the calibration method, may be applied to the embodiments of the present invention, and the present invention may not be limited to the disclosed method.

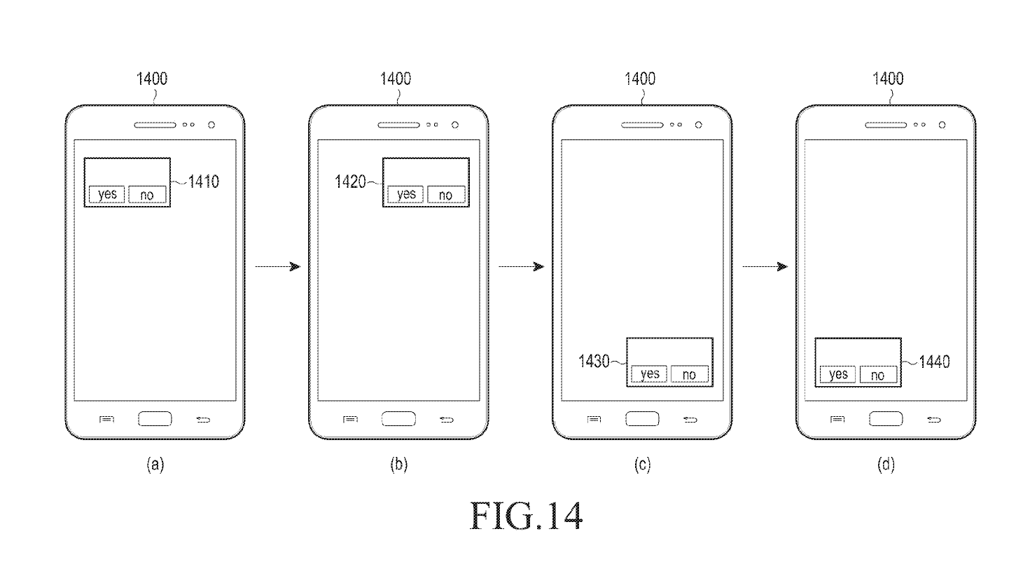

FIG. 14 illustrates changing of an event occurrence location according to various embodiments of the present invention. Referring to FIG. 14, calibration may be efficiently performed by variously changing a location where an event occurs on a screen of the electronic device 1400. For example, a first pop-up window 1410 may be displayed in the top left side of the screen as illustrated in FIG. 14A. A second pop-up window 1420 may be displayed in the top right side of the screen as illustrated in FIG. 14B. A third pop-up window 1430 may be displayed in the bottom right side of the screen as illustrated in FIG. 14C. A fourth pop-up window 1440 may be displayed in the bottom left side of the screen as illustrated in FIG. 14D. Calibration is performed by locating a pop-up window in various locations, thereby the efficiency and accuracy of the calibration may be increased.

Also, according to various embodiments of the present invention, a location where the pop-up window is displayed may be variously set by taking into consideration an application type of an application that is executed or a configuration of a screen that is displayed. For example, when a pop-up window for calibration is displayed according to various embodiments of the present invention, the location where the pop-up window is displayed may be determined by taking into consideration the disposition of a picture, text, an icon, and the like displayed on a screen.

Also, according to various embodiments of the present invention, the accuracy of calibration with respect to each location or each portion of the entire area on the screen of the electronic device 1400 may be compared, and the pop-up window may be displayed in a location or an area having a relatively low accuracy of calibration.

For example, according to various embodiments of the present invention, when a pop-up window generation event occurs while a user executes various applications, a location where the pop-up window is to be displayed may be set in advance and the pop-up window may be displayed in various locations. Also, the location where the pop-up window is to be displayed may be randomly set.

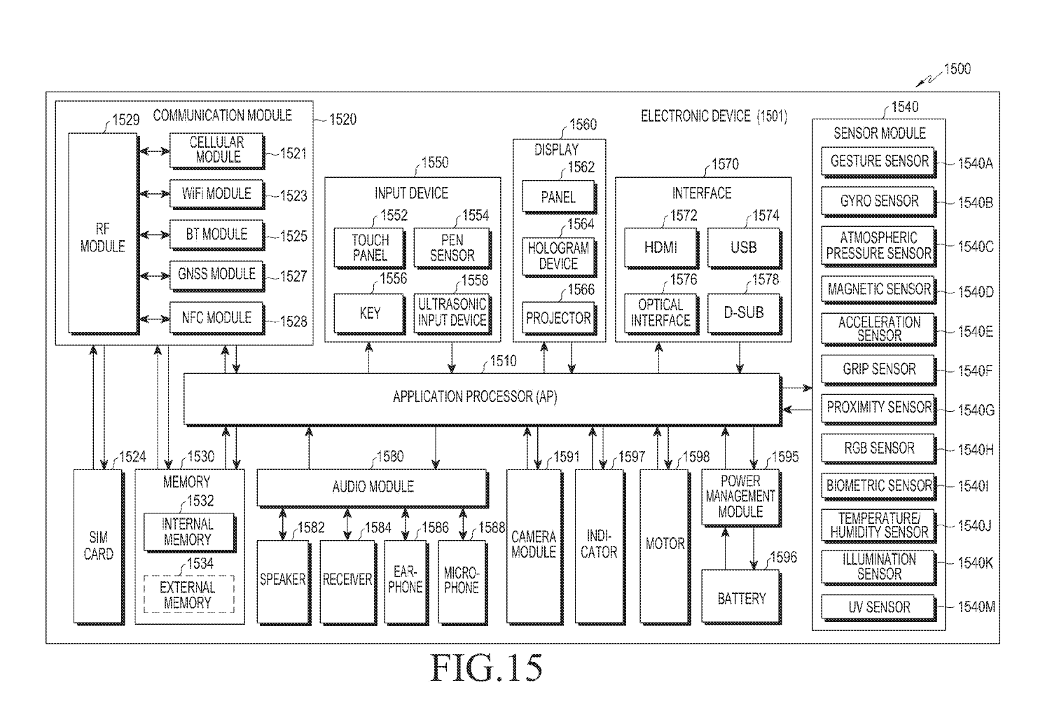

FIG. 15 is a block diagram 1500 of an electronic device 1501 according to various embodiments of the present invention. The electronic device 1501 may include, for example, a part or the entirety of the electronic device illustrated in FIG. 1. The electronic device 1501 may include at least one application processor (AP) 1510, a communication module 1520, a subscriber identification module (SIM) card 1524, a memory 1530, a sensor module 1540, an input device 1550, a display 1560, an interface 1570, an audio module 1580, a camera module 1591, a power management module 1595, a battery 1596, an indicator 1597, and a motor 1598.

The AP 1510 may control a plurality of hardware or software elements connected to the AP 1510 by driving an operating system or an application program, and may perform a variety of data processing and calculations. The AP 1510 may be embodied as, for example, a system on chip (SoC). According to one embodiment, the AP 1510 may further include a graphic processing unit (GPU) and/or an image signal processor. The AP 1510 may also include at least some (e.g., a cellular module 1521) of the elements illustrated in FIG. 15. The AP 1510 may load commands or data, received from at least one other element (e.g., a non-volatile memory), in a volatile memory to process the loaded commands or data, and may store various data in the non-volatile memory.

The communication module 1520 may include, for example, a cellular module 1521, a Wi-Fi module 1523, a BT module 1525, a GPS module 1527, an NFC module 1528, and a radio frequency (RF) module 1529.

The cellular module 1521 may provide a voice call, image call, SMS, or Internet service through, for example, a communication network. According to an embodiment, the cellular module 1521 may identify and authenticate the electronic device 1501 within a communication network by using a subscriber identification module (e.g., the SIM card 1524). According to an embodiment, the cellular module 1521 may perform at least some of the functions that the AP 1510 may provide. According to an embodiment, the cellular module 1521 may include a communication processor (CP).

Each of the Wi-Fi module 1523, the BT module 1525, the GPS module 1527, and the NFC module 1528 may include, for example, a processor for processing data transmitted/received through a corresponding module. According to some embodiments, at least some (e.g., two or more) of the cellular module 1521, the Wi-Fi module 1523, the BT module 1525, the GPS module 1527, and the NFC module 1528 may be included in one integrated chip (IC) or IC package.

The RF module 1529 may transmit/receive, for example, a communication signal (e.g., an RF signal). The RF module 1529 may include, for example, a transceiver, a power amp module (PAM), a frequency filter, a low noise amplifier (LNA), or an antenna. According to another embodiment, at least one of the cellular module 1521, the Wi-Fi module 1523, the BT module 1525, the GPS module 1527, and the NFC module 1528 may transmit/receive an RF signal through a separate RF module.

The SIM card 1524 may include, for example, a card including a subscriber identification module and/or an embedded SIM, and may further include unique identification information (e.g., an integrated circuit card identifier (ICCID)) or subscriber information (e.g., international mobile subscriber identity (IMSI)).

The memory 1530 may include, for example, an embedded memory 1532 or an external memory 1534. The embedded memory 1532 may include, for example, at least one of a volatile memory (e.g., a dynamic random access memory (DRAM), a static RAM (SRAM), a synchronous dynamic RAM (SDRAM), or the like), and a non-volatile memory (e.g., a onetime programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), a hard disc drive, or a solid state drive (SSD)).

The external memory 1534 may further include a flash drive, for example, a compact flash (CF), a secure digital (SD), a micro secure digital (Micro-SD), a mini secure digital (Mini-SD), an extreme digital (xD), a memory stick, or the like. The external memory 1534 may be functionally and/or physically connected to the electronic device 1501 through various interfaces.

The sensor module 1540 may, for example, measure a physical quantity or detect the operating state of the electronic device 1501 and may convert the measured or detected information to an electrical signal. The sensor module 1540 may include, for example, at least one of a gesture sensor 1540A, a gyro sensor 1540B, an atmospheric pressure sensor 1540C, a magnetic sensor 1540D, an acceleration sensor 1540E, a grip sensor 1540F, a proximity sensor 1540G, a color sensor 1540H (e.g., a red, green, blue (RGB) sensor), a biometric sensor 1540I, a temperature/humidity sensor 1540J, an illumination sensor 1540K, and a ultraviolet (UV) sensor 1540M. Additionally or alternatively, the sensor module 1540 may include, for example, an E-nose sensor, an electromyography (EMG) sensor, an electroencephalogram (EEG) sensor, an electrocardiogram (ECG) sensor, an infrared (IR) sensor, an iris scanner, and/or a fingerprint sensor. The sensor module 1540 may further include a control circuit for controlling at least one sensor included therein. In an embodiment, the electronic device 1501 may further include a processor that is configured, as a part of the AP 1510 or a separate element from the AP 1510, to control the sensor module 1540, and may control the sensor module 1540 while the AP 1510 is in a sleep state.

The input device 1550 may include, for example, a touch panel 1552, a (digital) pen sensor 1554, a key 1556, or an ultrasonic input device 1558. The touch panel 1552 may use at least one of, for example, a capacitive type, a resistive type, an infrared type, and an ultrasonic type. The touch panel 1552 may further include a control circuit. The touch panel 1552 may further include a tactile layer and provide a tactile reaction to a user.

The (digital) pen sensor 1554 may include, for example, a recognition sheet which is a part of the touch panel or a separate recognition sheet. The key 1556 may include, for example, a physical button, an optical key or a keypad. The ultrasonic input device 1558 may detect ultrasonic waves, which are generated by an input tool, through a microphone (e.g., a microphone 1588) in the electronic device 1501 to identify data

The display 1560 (e.g., the display unit 140) may include a panel 1562, a hologram device 1564, or a projector 1566. The panel 1562 may include a configuration equal or similar to the display unit 140 of FIG. 1. The panel 1562 may be implemented to be, for example, flexible, transparent, or wearable. The panel 1562 may also be integrated with the touch panel 1552 as a single module. The hologram device 1564 may show a stereoscopic image in the air using interference of light. The projector 1566 may project light onto a screen to display an image. For example, the screen may be located inside or outside the electronic device 1501. According to an embodiment, the display 1560 may further include a control circuit for controlling the panel 1562, the hologram device 1564, or the projector 1566.

The interface 1570 may include, for example, a high-definition multimedia interface (HDMI) 1572, a universal serial bus (USB) 1574, an optical interface 1576, or a D-subminiature (D-sub) 1578. Additionally or alternatively, the interface 1570 may include, for example, a mobile high-definition link (MHL) interface, a secure digital (SD) card/multi-media card (MMC) interface, or an infrared data association (IrDA) standard interface.

The audio module 1580 may bilaterally convert, for example, a sound and an electrical signal. The audio module 1580 may process voice information input or output through, for example, a speaker 1582, a receiver 1584, earphones 1586, or the microphone 1588.

The camera module 1591 may be, for example, a device that can take a still image or a moving image, and according to an embodiment, the camera module 1591 may include one or more image sensors (e.g., a front sensor or a rear sensor), a lens, an image signal processor (ISP), or a flash (e.g., an LED or a xenon lamp). At least some elements of the camera module 1591 may be included in, for example, the camera unit 130 illustrated in FIG. 1.

The power management module 1595 may manage, for example, power of the electronic device 1501. According to an embodiment, the power management module 1595 may include a power management integrated circuit (PMIC), a charger Integrated circuit (IC), or a battery or fuel gauge. The PMIC may use a wired and/or wireless charging method. The wireless charging method may include a magnetic resonance method, a magnetic induction method, an electromagnetic wave method, and the like. Additional circuits (e.g., a coil loop, a resonance circuit, a rectifier, and the like) for wireless charging may be further included. The battery gauge may measure, for example, the remaining charge of the battery 1596, or a voltage, a current, or a temperature while charging. The battery 1596 may include, for example, a rechargeable battery or a solar battery.

The indicator 1597 may indicate a particular state of the electronic device 1501 or a part thereof (e.g., the AP 1510), for example, a booting state, a message state, a charging state, or the like. The motor 1598 may convert an electrical signal into mechanical vibrations, and may generate a vibration or haptic effect. Although not illustrated, the electronic device 1501 may include a processing device (e.g., a GPU) for supporting mobile TV. The processing device for supporting mobile TV may process media data according to a standard of digital multimedia broadcasting (DMB), digital video broadcasting (DVB), media flow or the like.

Each of the components of the electronic device according to the present invention may be implemented by one or more components and the name of the corresponding component may vary depending on a type of the electronic device. In various embodiments, the inspection apparatus may include at least one of the above-described elements. Some of the above-described elements may be omitted from the electronic device, or the inspection apparatus may further include additional elements. Further, some of the components of the electronic device according to the various embodiments of the present invention may be combined to form a single entity, and thus, may equivalently execute functions of the corresponding elements prior to the combination.

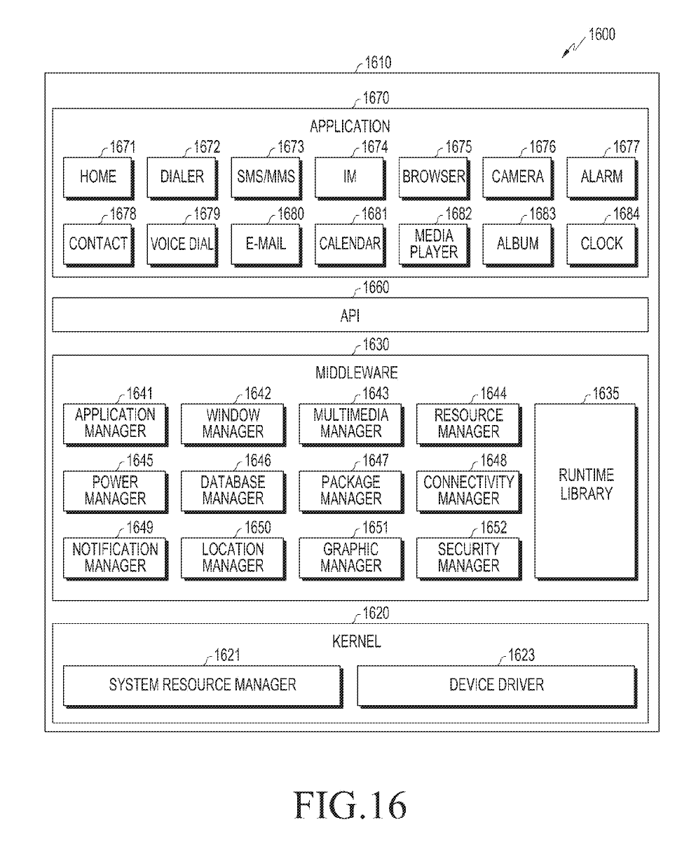

FIG. 16 is a block diagram 1600 of a program module 1610 according to various embodiments of the present invention. According to an embodiment, the program module 1610 may include an operating system (OS) that controls resources related to an electronic device and/or various applications (e.g., application programs) driven in the OS. The operating system may be, for example, Android, iOS, Windows, Symbian, Tizen, Bada, or the like.

The program module 1610 may include a kernel 1620, a middleware 1630, an application programming interface (API) 1660, and/or applications 1670. At least some of the program module 1610 may be preloaded to the electronic device, or may be downloaded from a server.

The kernel 1620 may include, for example, a system resource manager 1621 or a device driver 1623. The system resource manager 1621 may control, allocate, or retrieve the system resources. According to one embodiment, the system resource manager 1621 may include a process management unit, a memory management unit, a file system management unit, or the like. The device driver 1623 may include, for example, a display driver, a camera driver, a Bluetooth driver, a shared-memory driver, a USB driver, a keypad driver, a Wi-Fi driver, an audio driver, or an inter-process communication (IPC) driver.

The middleware 1630 may provide a function required by the applications 1670 in common or provide various functions to the applications 1670 through the API 1660 so that the applications 1670 can efficiently use limited system resources of the electronic device. According to an embodiment, the middleware 1630 may include at least one of a run time library 1635, an application manager 1641, a window manager 1642, a multimedia manager 1643, a resource manager 1644, a power manager 1645, a database manager 1646, a package manager 1647, a connectivity manager 1648, a notification manager 1649, a location manager 1650, a graphic manager 1651, and a security manager 1652.

For example, the application manager 1641 may manage a life cycle of at least one of the applications 1670. The window manager 1642 may manage a GUI resource used in the screen. The multimedia manager 1643 may detect a format required for reproducing various media files and encode or decode a media file using a codec appropriate for the corresponding format. The resource manager 1644 may manage resources, such as a source code, a memory, a storage space, or the like, of at least one of the applications 1670.

The power manager 1645 may interoperate with a basic input/output system (BIOS) to manage a battery or power and may provide power information required for the operation of the electronic device. The database manager 1646 may generate, search, or change a database to be used by at least one of the applications 1670. The package manager 1647 may manage the installation or update of applications distributed in a package file form.

For example, the connectivity manager 1648 may manage wireless connections, such as Wi-Fi or Bluetooth. The notification manager 1649 may display or notify an event such as a received message, an appointment, and a proximity notification to a user without disturbance. The location manager 1650 may manage location information of the electronic device. The graphic manager 1651 may manage graphic effects to be provided to a user or user interfaces related to the graphic effects. The security manager 1652 may provide various security functions required for system security or user authentication. According to an embodiment of the present invention, when the electronic device (e.g., the electronic device of FIG. 1) has a telephoning function, the middleware 1630 may further include a telephony manager for managing a voice or video call function of the electronic device.

The middleware 1630 may include a middleware module for forming a combination of various functions of the aforementioned elements. The middleware 1630 may provide modules specialized according to the type of OS in order to provide differentiated functions. In addition, a few exiting elements may be dynamically removed from the middleware 1630, or new elements may be added to the middleware 1630.

The API 1660 is a set of API programming functions and may include different configurations according to operating systems. For example, with respect to each platform, one API set may be provided in the case of Android or iOS, and two or more API sets may be provided in the case of Tizen.

The applications 1670 may include one or more applications that may provide a function of home 1671, a dialer 1672, an SMS/MMS 1673, instant messaging (IM) 1674, a browser 1675, a camera 1676, an alarm 1677, contacts 1678, a voice dial 1679, e-mail 1680, a calendar 1681, a media player 1682, an album 1683, a clock 1684, health care (e.g., measuring a work rate or blood sugar), providing environmental information (e.g., providing atmospheric pressure, humidity, or temperature information), or the like.

According to an embodiment, the applications 1670 may include an application (hereinafter, referred to as “an information exchange application” for convenience of description) for supporting exchanging of information between the electronic device (e.g., the electronic device of FIG. 1) and an external electronic device. The information exchange application may include, for example, a notification relay application for transmitting specific information to the external electronic device, or a device management application for managing the external electronic device.

For example, the notification relay application may include a function of transferring, to the external electronic device, notification information generated from the other applications of the electronic device (e.g., the SMS/MMS application, the e-mail application, the health management application, and the environmental information application). Further, the notification relay application may receive notification information from, for example, the external electronic device and provide the received notification information to a user. The device management application, for example, may manage (e.g., install, delete, or update) at least one function of an external electronic device communicating with the electronic device (e.g., a function of turning on/off the external electronic device itself (or some components thereof) or a function of controlling the luminance (or a resolution) of the display), applications operating in the external electronic device, or services provided by the external electronic device (e.g., a telephone call service and a message service).

According to an embodiment, the applications 1670 may include an application (e.g., health management application) designated according to attributes of the external electronic device (e.g., attributes of the electronic device, such as the type of electronic device which corresponds to a mobile medical device). According to an embodiment, the applications 1670 may include an application received from the external electronic device. According to an embodiment, the applications 1670 may include a preloaded application or a third party application that can be downloaded from a server. The names of the elements of the program module 1610, according to the embodiment illustrated in the drawing, may vary according to the type of operating system.

According to various embodiments of the present invention, at least some of the above described operations of FIGS. 2 to 6 may be implemented by the applications 1670 or by at least one of the OS (e.g., the API 1660, the middleware 1630, and the kernel 1620). Also, at least some of the above described operations of FIGS. 2 to 6 may be implemented in a dedicated processor (e.g., an AP or CP) configured as hardware.

According to various embodiments, at least a part of the programming module 1610 may be embodied as software, firmware, hardware, or a combination of two or more thereof. At least some of the programming module 1610 may be implemented (e.g., executed) by, for example, the processor (e.g., the AP 1510). At least some of the programming module 1610 may include, for example, a module, a program, a routine, sets of instructions, or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” or “function unit” may be a minimum unit of an integrated component element or a part thereof. The “module” may be a minimum unit for performing one or more functions or a part thereof. The “module” or “function unit” may be mechanically or electronically implemented. For example, the “module” according to the present invention may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present invention may be implemented by a command stored in a computer-readable storage medium in a programming module form. When the command is executed by one or more processors (for example, the processor 110), the one or more processors may execute a function corresponding to the command. The computer-readable storage medium may be, for example, the memory 160.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware electronic device may be configured to operate as one or more software modules in order to perform the operation of the present invention, and vice versa.

The programming module according to the present invention may include one or more of the aforementioned components or may further include other additional components, or some of the aforementioned components may be omitted. Operations executed by a module, a programming module, or other component elements according to various embodiments of the present invention may be executed sequentially, in parallel, repeatedly, or in a heuristic manner. Furthermore, some operations may be executed in a different order or may be omitted, or other operations may be added.

According to various embodiments, there is provided a storage medium storing instructions. The instructions are set to enable at least one processor to perform at least one operation when the instructions are executed by the at least one processor, the at least one operation including: when at least one event occurs in an electronic device, determining whether the event is a predetermined event; capturing an image through a camera when the event is the predetermined event; and calibrating a user gaze, which is determined from the captured image, based on location information associated with a location on a screen corresponding to the event.

Various embodiments of the present invention disclosed in this specification and the drawings are merely specific examples presented in order to easily describe technical details of the present invention and to help the understanding of the present invention, and are not intended to limit the scope of the present invention. Therefore, it should be construed that, in addition to the embodiments disclosed herein, all modifications and changes or modified and changed forms derived from the technical idea of various embodiments of the present invention fall within the scope of the present invention.

1. An electronic device, comprising:
a camera unit that captures an image in response to an operation of displaying an event in a location on a screen of the electronic device; and
a controller that performs control to calibrate a gaze based on information associated with a user gaze determined from the captured image, and location information associated with the location on the screen where the event is displayed.

2. The electronic device as claimed in claim 1, wherein the event is a predetermined event and of which location information associated with the location where the event is displayed on the screen is identifiable.

3. The electronic device as claimed in claim 2, wherein the event is an input event associated with selecting at least one location on the screen.

4. The electronic device as claimed in claim 3, wherein the input event is a selection event by an input unit to select a location of a cursor displayed on the screen, a touch event on a touch screen, or a user gesture event.

5. The electronic device as claimed in claim 2, wherein the event is an output event associated with an object generated on at least one location on the screen.

6. The electronic device as claimed in claim 5, wherein the output event is a pop-up window generation event that generates a pop-up window on at least one location on the screen.

7. The electronic device as claimed in claim 6, wherein the pop-up window is generated in a location that is different from a previous generation location according to settings.

8. The electronic device as claimed in claim 1, wherein the location information associated with the location on the screen is coordinate information indicating at least one point on a display screen or information associated with an area including the at least one coordinate.

9. The electronic device as claimed in claim 1, wherein, when a result obtained by comparing predetermined calibration information and calibration information determined when the event occurs exceeds a predetermined error range, the controller updates calibration information with the calibration information determined when the event occurs.

10. The electronic device as claimed in claim 1, wherein the controller performs control to identify a user from the captured image, and to store calibration information generated from the captured image to correspond to user information of the user.

11. A gaze calibration method of an electronic device, the method comprising:
when at least one event occurs in the electronic device, determining whether the event is a predetermined event;
capturing an image through a camera when the event is the predetermined event; and
calibrating a user gaze, which is determined from the captured image, based on location information associated with a location on a screen corresponding to the event.

12. The method as claimed in claim 11, wherein the event is a predetermined event and of which location information associated with a location on the screen corresponding to the event is identifiable.

13. The method as claimed in claim 12, wherein the event is an input event associated with selecting at least one location.

14. The method as claimed in claim 13, wherein the input event is a selection event by an input unit to select a location of a cursor displayed on the screen, a touch event on a touch screen, or a user gesture event.

15. The method as claimed in claim 12, wherein the event is an output event associated with an object that is generated on at least one location on the screen.

16. The method as claimed in claim 15, wherein the output event is a pop-up window generation event that generates a pop-up window on at least one location on the screen.

17. The method as claimed in claim 16, wherein the pop-up window is generated in a location that is different from a previous generation location according to settings.

18. The method as claimed in claim 11, wherein the location information associated with the location on the screen is coordinate information indicating at least one point on a display screen or information associated with an area including the at least one coordinate.

19. The method as claimed in claim 11, further comprising:
comparing predetermined calibration information and calibration information determined when the event occurs; and
updating calibration information with the calibration information determined when the event occurs when a comparison result exceeds a predetermined error range.

20. The method as claimed in claim 11, further comprising:
identifying a user from the captured image; and
storing calibration information generated from the captured image to correspond to user information of the user.
